(19) United States
(12) Patent Application Publication
(10) Pub. No.: US 2022/0126676 A1
(43) Pub. Date: Apr. 28, 2022

(54) Hybrid Transmission Device and Motor Vehicle

(71) Applicant: ZF Friedrichshafen AG, Friedrichshafen (DE)

(72) Inventors: Stefan Beck, Eriskirch (DE); Fabian Kutter, Kressbronn (DE); Matthias Horn, Tettnang (DE); Johannes Kaltenbach, Friedrichshafen (DE); Michael Wechs, Weißensberg (DE); Thomas Martin, Weissensberg (DE); Martin Brehmer, Tettnang (DE); Peter Ziemer, Tettnang (DE); Thomas Kroh, Lindau (DE); Oliver Bayer, Hörbranz (AT); Max Bachmann, Friedrichshafen (DE)

(21) Appl. No.: 17/437,919

(22) PCT Filed: Oct. 15, 2019
(86) PCT No.: PCT/EP2019/077886

§ 371 Date: Sep. 10, 2021

(30) Foreign Application Priority Data
Mar. 20, 2019 (DE) 10 2019 203 766.6

(51) Int. Cl. B60K 6/547; B60K 6/48; B60K 6/387

(52) U.S. Cl. CPC B60K 6/547; B60K 2006/4825; B60K 6/387; B60K 6/48

(57) ABSTRACT

A hybrid transmission device (3) includes a first transmission input shaft (12), a second transmission input shaft (14), at least one drive device (EM2), and a connecting clutch (K3) engageable to rotationally fix the first transmission input shaft (12) to the second transmission input shaft (14). The first transmission input shaft (12) extends between an input side (21) and an output side (23), where the first transmission input shaft (12) is clutch-free on the input side (21).

### CROSS-REFERENCE TO RELATED APPLICATION

The present application is related and has right of priority to German Patent Application No. 10 2019 203 766.6 filed on Mar. 20, 2019 and is a nationalization of PCT/EP2019/077886 filed in the European Patent Office on Oct. 15, 2019, both of which are incorporated by reference in their entirety for all purposes.

### FIELD OF THE INVENTION

The invention relates generally to a hybrid transmission device with a first transmission input shaft, a second transmission input shaft, at least one drive device, and a connecting clutch for the rotationally fixed connection of the first transmission input shaft and the second transmission input shaft.

### BACKGROUND

It is known to utilize hybrid transmission devices to reduce the CO2 emissions of motor vehicles. A hybrid transmission device is understood to be a transmission device with which an internal combustion engine and at least one further drive device are couplable. It is known to hybridize all automated transmissions, for example, automatic transmissions and dual clutch transmissions. DE10 2011 005 451 A1 describes a transmission which includes two electric motors and is capable of providing five forward gears and one reverse gear.

### SUMMARY OF THE INVENTION

On the basis thereof, the object of the present invention is to provide a hybrid transmission device, is compact for front-transverse applications and offers even greater functionality.

In order to solve this problem, it is provided that the first transmission input shaft is clutch-free on the input side. As a result, installation space is saved and the efficiency of the hybrid transmission device is improved.

The input side of the first transmission input shaft is without a clutch. In particular, the input side of the first transmission shaft is the side or end of the first transmission shaft toward or closest to an internal combustion engine. Therefore, there is no clutch arranged between a crankshaft of the internal combustion engine and the first transmission input shaft. Nevertheless, the crankshaft and the first transmission input shaft do not need to be rigidly connected to one another. Rather, advantageously, a damping arrangement is provided between the crankshaft and the first transmission input shaft. The crankshaft and the first transmission input shaft are connected to each other in a rotationally fixed manner.

The damping arrangement includes one or more of a torsion damper, a damper, and a slipping clutch. The torsion damper is preferably a dual-mass flywheel, although less complex embodiments are also known. The damper is preferably a rotational speed-adaptive damper.

In addition, two damper units are also provided, for example, a dual-mass flywheel at the end of the crankshaft and a second torsion damper in the transmission.

The transmission of the hybrid transmission device is advantageously a gear change transmission having at least two discrete gear steps.

Advantageously, the gear change transmission includes at least two sub-transmissions, preferably precisely two sub-transmissions. This allows for increased functionality and, for example, tractive force support during a gear change, in particular an internal-combustion-engine gear change as well as an electric gear change.

Preferably, at least one of the sub-transmissions is a gear change transmission. In particular, two or more sub-transmissions, preferably precisely two sub-transmissions, are gear change transmissions. In this case, one sub-transmission has at least two gear steps, and the further sub-transmission has at least one gear step.

Advantageously, one sub-transmission has precisely three gear steps. In addition, a second sub-transmission has precisely two gear steps.

The internal combustion engine is also simultaneously fixedly connected to one of the sub-transmissions, since the internal combustion engine is fixedly connected to the first transmission input shaft.

Advantageously, the gear change transmission includes gearwheels and shift elements. The gearwheels are preferably spur gears.

Preferably, the transmission of the hybrid transmission device is a stationary transmission. In stationary transmissions, the axles of all gearwheels in the transmission are fixed in relation to the transmission housing.

Preferably, the gear change transmission is a countershaft transmission. Preferably, the gear change transmission is a spur gear drive. The gearwheels are spur gears in this case.

In addition, the transmission preferably includes at least two transmission input shafts. Preferably, the transmission includes precisely two transmission input shafts. With three or more transmission input shafts, although a larger number of sub-transmissions are produced, it has been proven that the described functionality is already achieved with two transmission input shafts.

Preferably, the first transmission input shaft is a solid shaft. Regardless of the first transmission input shaft configuration, in a first embodiment, the second input shaft is a hollow shaft mounted on the first transmission input shaft, i.e., it is arranged coaxially thereto and encloses it. In another embodiment, the second transmission input shaft is arranged on a rotational axis with the first transmission input shaft, but axially offset from the first transmission input shaft.

Preferably, the hybrid transmission device includes at least one countershaft, in particular embodiments, precisely one countershaft. In the case that a single countershaft is utilized, a single point of connection to the differential is present. As a result, installation space is saved in the radial direction and in the axial direction.

Therefore, the transmission in one preferred embodiment includes precisely three shafts, namely two transmission input shafts and one countershaft, where the countershaft is also the output shaft.

In an all-wheel drive variant of the transmission, one shaft is always added, which, as a power take-off, drives the second motor vehicle axle.

A gear step, as already described at the outset, is a mechanically implemented gear ratio between two shafts. The overall gear ratio between the internal combustion engine or the drive device and the wheel has further ratios, wherein the ratios upstream from a gear step, the so-called pre-ratios, depend on the output that is utilized. The post-ratios are usually identical. In an embodiment shown further below, for a pre-ratio, the rotational speed and the torque of a drive device are transmitted multiple times, namely by at least one gearwheel pair between the output shaft of the drive device and a transmission input shaft. The pre-ratio is followed by a gearwheel pair of a gear step with a ratio dependent on the gear step, and then finally followed by a post-ratio, with a gearwheel pair between the countershaft and the differential. A gear has an overall gear ratio that depends on the input and the gear step. Unless indicated otherwise, a gear relates to the utilized gear step.

Merely for the sake of clarity, it is pointed out that the ascending numbers of the gear steps refer, as usual, to a descending ratio. A first gear step has a higher ratio than a second gear step, etc.

If torque is transmitted from the internal combustion engine via the first gear step, this is referred to as an internal-combustion-engine gear. If the drive device and the internal combustion engine simultaneously transmit torque via the second gear step, this is referred to as a hybrid gear. If only the drive device transmits torque via the second gear step, this is referred to as an electric gear.

In the following, gear steps refer to forward gear steps. Preferably, the transmission of the hybrid transmission device has at least three gear steps or gear stages. The gearwheels of a gear step are arranged in a gear plane when the gear step includes two gear-step gears. In a first embodiment, the transmission has at least four gear steps or gear stages. In a further embodiment, the transmission preferably has at least five gear steps or gear stages, preferably precisely five, gear steps or gear stages.

Preferably, the transmission of the hybrid transmission device has one more gear plane than gear steps. For example, when the transmission includes five gears, the transmission includes six gear planes. The gear plane for connecting the drive output, for example, a differential, is included in the count.

In a first alternative, all gear steps of at least one sub-transmission are utilized in an internal combustion engine-driven and electric or fluidic manner. As a result, a maximum number of gears is obtained given a low number of gear steps. Preferably, all gear steps of precisely one sub-transmission are utilized in an internal combustion engine-driven and electric or fluidic manner, and the gear steps of the other sub-transmission(s) are utilized exclusively in an internal combustion engine-driven manner.

Advantageously, the hybrid transmission device and/or the transmission is free from or without a reversing gearwheel for reversing the direction. Therefore, the reverse gear is not produced via the internal combustion engine, but rather via the electric motor or at least one of the electric motors. In this case, for example, the second gear step is utilized.

Preferably, gear-step gearwheels for all odd gear steps are arranged on the first transmission input shaft. In addition, gear-step gears of all even gear steps are preferably arranged at the second transmission input shaft. Gear-step gears, which are also referred to as gear-step gearwheels, are fixed gears or idler gears.

They are referred to as gear-step gears, because they are associated with a gear step.

Preferably, the highest even gear step and/or one of the gear-step gears associated therewith are/is located at the axial end of the transmission input shaft that supports one of the gear-step gearwheels of the highest even gear step. The axial end is advantageously also facing the transmission housing. Preferably, the highest even gear step is the fourth gear step and/or the transmission input shaft is the second transmission input shaft.

Preferably, the highest odd gear step and/or one of the gear-step gears associated therewith are/is located in the center of the gear-step gearwheels on the axis of the first transmission input shaft.

Preferably, the highest electric gear step and/or one of the gear-step gears associated therewith are/is located at the axial end of the transmission input shaft that supports one of the gear-step gearwheels of the highest electric gear step. Preferably, the highest electric gear step is a fourth gear step and/or the transmission input shaft is the second transmission input shaft.

Preferably, the gear-step gears of the fourth gear step and of the second gear step are arranged on the second transmission input shaft from the outer side of the hybrid transmission device toward the inner side.

Preferably, the gear-step gears of the third gear step, the first gear step, and the fifth gear step are arranged on the first transmission input shaft from the outer side of the hybrid transmission device toward the inner side.

Preferably, the hybrid transmission device includes precisely one drive device. An arrangement of one or multiple drive device(s) that act(s) at a certain point of the hybrid transmission device counts as a drive device. This means, for example, in an embodiment of the drive device as an electric motor, that multiple small electric motors are also considered to be one electric motor if they summarize their torque at a single starting point.

Advantageously, the drive device is associated with the second transmission input shaft. The gears implemented via the first transmission input shaft and the gears implemented via the second transmission input shaft form a sub-transmission in each case. It may therefore also be stated that a drive device is exclusively associated with one sub-transmission. Preferably, the hybrid transmission device includes at least two sub-transmissions, preferably precisely two, sub-transmissions.

Preferably, the drive device is a combination of a motor and a generator. It is then also utilized for charging the energy accumulator.

Preferably, the drive device is connected to the highest gear step of the sub-transmission, with which it is associated.

Preferably, the drive device is connected to an axially externally situated gear step, more precisely, to one of the gearwheels of the gear step, of the transmission.

At this point, in accordance with example aspects of the present invention, a connection or operative connection refers to any power flow-related connection, also across other components of the transmission. A connection, however, refers to the first connecting point for transmitting drive torque between the prime mover and the transmission.

A connection to a gear step, i.e., one of its gear-step gearwheels, takes place via a gearwheel. An additional intermediate gear may be necessary, in order to bridge the center distance between the output shaft of the drive device and the transmission input shaft. Due to the connection of the drive device to a gear-step gearwheel, a further gear plane is avoided, which would be present only for the connection of the drive device.

Advantageously, at least one of the axially external gear-step gears, which are arranged on the axis of the transmission input shafts, is a fixed gear. Preferably, both axially external gear-step gears are fixed gears. In this case, the drive device is connected to a fixed gear on the second transmission input shaft. The drive device is therefore preferably arranged in a so-called P3 arrangement, i.e., at the transmission gear set.

Preferably, the drive device is connected to the fourth gear stage.

Preferably, the drive device is utilized for an electric or fluidic forward starting operation. In this case, the drive device is coupled, advantageously, to the gear-step gears of the second gear. The drive device is preferably utilized as a sole drive source for the starting operation. Similarly, the drive device is utilized for electric or fluidic travel in reverse. Preferably, it is also provided that the drive device is the sole drive source during travel in reverse. In this case, there are no internal-combustion-engine or hybrid reverse gears.

Preferably, the drive device is arranged axially parallel to the first transmission input shaft. It is then preferably also axially parallel to the second transmission input shaft and to the countershaft. According to example aspects of the present invention, an axially parallel arrangement refers not only to completely parallel arrangements. An inclination or an angle between the longitudinal axis of the transmission input shafts and the longitudinal axis of the electric motor is also present. Preferably, an angle is provided between the longitudinal axis of an electric motor and the longitudinal axis of the transmission input shafts of less than or equal to 10°, further preferably less than 5° and, in particular, preferably 0°. Slight inclinations of the drive device in comparison to the transmission result for reasons related to installation space.

Preferably, the axis of the drive device in the installation position is situated above the axis of the transmission input shaft. The installation position is always referenced in the following. During installation, in some example embodiments, the hybrid transmission device is also upside down. Such positions are irrelevant for the following description, however. While the axially parallel arrangement also makes it possible for the drive device to be located below the axis of the transmission input shaft, it is advantageously provided that the drive device and, thereby, its axis is positioned above the transmission input shaft. In this arrangement, the packing density is maximized.

Preferably, the axis of the drive device in the installation position is situated above the axes of one or multiple countershaft(s) and/or one or multiple output shaft(s). The drive device is therefore situated above the aforementioned components of the spur gear drive arrangement. Alternatively, in one example embodiment, the axis of the drive device in the installation position is the uppermost axes of the hybrid transmission device.

The drive device is arranged in the axial direction preferably at the same level as the gear change transmission. Preferably, the overlap in the axial direction is more than 75%. Advantageously, it is 100%. Here, the overlap is ascertained on the basis of the housing of the drive device. The output shaft of the drive device is not taken into account.

Advantageously, the drive device is rotationally fixed to the second transmission input shaft, in particular connected to the second transmission input shaft. When the second transmission input shaft is arranged in such a way that it is connectable to the internal combustion engine by the first transmission input shaft, the drive device is utilized in many operating situations as a parallel drive source with respect to the internal combustion engine.

Preferably, the drive device is an electric motor. Electric motors are widespread in hybrid transmission devices.

Alternatively, the drive device is a fluid power machine. In addition to electric motors, there are other prime movers, the utilization of which in hybrid transmission devices is conceivable. The prime movers are also operable as motors, i.e., in a manner that consumes energy, or as generators, i.e., in a manner that converts energy. In the case of a fluid power machine, the energy accumulator is, for example, a pressure reservoir. The energy conversion then consists of converting the energy from the internal combustion engine into a pressure build-up.

Advantageously, the drive device is power-shifted. A powershift is understood here, as usual, to mean that no interruption of tractive force occurs at the output of the hybrid transmission device during a gear change, for example, of the drive device. A reduction of the torque present at the output is possible, but a complete interruption is not.

For a purely electric powershift, for example, an electric axle as described further below is utilized.

As a result, the motor vehicle is continuously driven in large speed ranges, for example, exclusively electrically, wherein the ratio, i.e., the gear, is selected in each case so as to be optimized with respect to the rotational speed and torque of the drive device.

The connecting clutch is utilized for coupling the sub-transmission. However, it is also a clutch for connecting the second transmission input shaft to the internal combustion engine, wherein the connection extends via the first transmission input shaft.

Preferably, the connecting clutch is arranged at the end of the second transmission input shaft facing the transmission and further from the internal combustion engine 2. As a result, it becomes possible to provide two clutches on the engine side, with which the first transmission input shaft as well as the second transmission input shaft are connectable to the internal combustion engine.

Advantageously, the connecting clutch is part of a two-sided engagement device. The connecting clutch, due to its positioning, is integratable into a two-sided engagement device. Preferably, the engagement device includes the connecting clutch and the gearshift clutch of the highest gear step. When the connecting clutch is engaged, the internal combustion engine is synchronized by the drive device, while the tractive force is supported by an electric axle described in greater detail further below. The synchronization by the drive device is possible in all internal-combustion-engine gears, except in the case of the gearshift clutch forming a two-sided engagement device together with the connecting clutch. The highest gear step of the transmission is therefore selected here, since the tractive force demands are lowest here. In this gear change, the connecting clutch remains engaged during the entire gear change.

According to example aspects of the present invention, an engagement device is understood to be an arrangement with one or two shift element(s). The engagement device is one-sided or two-sided. A shift element is a clutch or a gearshift clutch. A “connecting clutch” is utilized for connecting two shafts in a rotationally fixed manner and a “gearshift clutch” is utilized for rotationally fixing a shaft to a hub rotatably mounted thereon, for example, an idler gear. The connecting clutch described above, therefore, is a “gearshift clutch” and, preferably, also as part of a gearshift clutch and is referred to as a “connecting clutch” only because it connects two shafts to one another. Clutches for connecting the transmission input shafts to a crankshaft of the internal combustion engine are not provided.

Preferably, at least some of the clutches and/or gearshift clutches are dog clutches. In particular, all clutches and gearshift clutches are dog clutches.

Advantageously, at least one engagement device is arranged on the first transmission input shaft. In a first alternative, precisely one gearshift clutch is arranged on the first transmission input shaft. Alternatively, at least two, in particular precisely two, engagement devices are arranged on the first transmission input shaft, as a two-sided engagement device.

One of the engagement devices on the first transmission input shaft preferably includes a gearshift clutch and a clutch.

Advantageously, the second transmission input shaft is engagement device-free and/or idler gear-free. Preferably, at least one fixed gear is arranged on the second transmission input shaft. In particular, at least two, in particular precisely two, fixed gears are arranged on the second transmission input shaft.

Preferably, at least one, in particular precisely one, idler gear is arranged on the first transmission input shaft.

Preferably, at least two, in particular precisely two, fixed gears are arranged on the first transmission input shaft.

Advantageously, one fixed gear and one idler gear are associated with each gear step and, in fact, a single fixed gear and a single idler gear in each case. In addition, each fixed gear and idler gear is always unambiguously associated with a single gear step, i.e., there are no winding-path gears by utilizing one gearwheel for multiple gears. Nevertheless, the second and fourth internal-combustion-engine gears are considered to be winding-path or coupling gears, as described below, since the first transmission input shaft is interconnected during the formation of the gears.

In one preferred embodiment, the hybrid transmission device and/or the transmission includes precisely three two-sided engagement devices for producing five internal-combustion-engine gear stages. The connecting clutch advantageously forms part of one of the three, two-sided engagement devices.

Preferably, a differential is arranged in the axial direction at the level of a damper unit at the end of a transmission input shaft. Advantageously, a gearwheel for connecting the differential is arranged axially externally on a countershaft. The connection preferably takes place at the side of the internal combustion engine.

Preferably, the hybrid transmission device includes at least one, in particular precisely one, countershaft. In the case that a single countershaft is utilized, a single point of connection to the differential is present. As a result, installation space is saved, which is the case in the radial direction as well as in the axial direction.

Preferably, at least two, in particular precisely two, engagement devices are arranged on the countershaft. In addition, advantageously, precisely four idler gears are arranged on the countershaft. Advantageously, all the engagement devices on the countershaft are two-sided.

The engagement devices arranged on the countershaft are arranged offset in the axial direction with respect to one or multiple engagement device(s) on one of the transmission input shafts, in particular the first transmission input shaft. In particular, the engagement devices on the countershaft enclose an engagement device on the first transmission input shaft in the axial direction. This means, the engagement devices are not only axially offset, but rather that the one engagement device on the countershaft is located to the left of the engagement device on the first transmission input shaft and the other engagement device on the countershaft is located to the right thereof, as viewed in a gear set scheme. When the transmission is viewed in the direction longitudinally to the transmission, the one engagement device is situated in front of the engagement device and the other behind the engagement device on the first transmission input shaft. The enclosed engagement device is advantageously arranged at one end of the second transmission input shaft.

Preferably, all shift elements of the engagement devices on the countershaft are gearshift clutches.

Preferably, at least one, in particular precisely one, fixed gear is located on the countershaft for forming a forward gear step. In addition, a fixed gear is located on the countershaft for establishing a connection to the differential. However, this is not a fixed gear for forming a forward gear step.

Advantageously, a single fixed gear for forming a forward gear step is arranged on the countershaft, and at least one idler gear is arranged on both sides of the fixed gear. Preferably, at least two idler gears, preferably precisely two idler gears are located on both sides of the fixed gear.

In addition, the hybrid transmission device includes a control device. The control device is for controlling the transmission as described.

For example, a gear change is carried out in two different ways:

First, the drive device assists in synchronization. A possible internal-combustion-engine gear change from the first internal-combustion-engine gear into the second internal-combustion-engine gear is then carried out as follows:

Initially, the connecting clutch and the gearshift clutch of the first gear step are engaged. In the gear shift matrix shown further below, the connecting clutch is represented as disengaged, because it is without load. An engagement is advantageous, however, for the described gear change.

In order to unload the gearshift clutch to be disengaged, the drive device compensates for the torque of the internal combustion engine by acting as a generator, and so the internal combustion engine remains under load. The torque of the internal combustion engine is slightly reduced, and so the drive device also applies the necessary torque. Thereupon, the gearshift clutch of the first gear step is disengaged.

The synchronization to the new gear preferably takes place in that the drive device takes over the dynamic closed-loop control of the rotational speed and the torque at the internal combustion engine remains constant or only a slow torque change takes place. Thereupon, the gearshift clutch of the new gear stage is engaged. The connecting clutch remains engaged.

As a result, short shift times are achieved due to short synchronization phases. In addition, the battery is charged during the gear shift. An electric axle is utilized in order to support the tractive force. Otherwise, the tractive force is interrupted during the gear shift.

In order to counteract this interruption of tractive force even without an electric axle, a gear shift is also carried out, alternatively, as follows:

While the internal combustion engine changes the gear, the drive device supports the tractive force via one of the electric gears. Thereupon, the internal combustion engine must synchronize itself to the new gear on its own. During a gear change from the first internal-combustion-engine gear into the second internal-combustion-engine gear, initially, the gearshift clutch of the first gear step is engaged. The gearshift clutch of the second gear step is engaged, but it is not in the torque path of the internal combustion engine when the connecting clutch is disengaged. The electric gear E2 is utilized, however.

A load reduction takes place at the internal combustion engine, and so the gearshift clutch of the first gear step is unloaded. Simultaneously, a load build-up takes place at the drive device, in order to support the tractive force via E2.

Thereupon, the gearshift clutch of the first gear step is disengaged, and the internal combustion engine regulates the rotational speed in such a way that the connecting clutch is synchronized. The connecting clutch is then engaged. After the engagement of the connecting clutch, the torque distribution between the internal combustion engine and the drive device is freely selectable. The second internal-combustion-engine gear is engaged.

As a result, a good shifting comfort is achieved even without an electrically driven rear axle.

In particular, a switch is also carried out between the two gear change methods. For example, the control device utilizes the first alternative during a sporty traveling mode or a low state of charge of the battery of the drive device.

The second alternative is utilized, however, when the gear shift is to take place with a great amount of tractive force, such as, for example, in a comfort mode.

In order to charge the battery and travel with an electric axle, it is provided to engage the connecting clutch, and so the internal combustion drives the drive device as a generator in order to generate power.

In addition, example aspects of the invention relates to a hybrid drive train including a hybrid transmission device and at least one electric axle, in particular a rear axle. The hybrid drive train is distinguished by the fact that the hybrid transmission device is preferably arranged with a single drive device in the hybrid transmission device. An electric axle is an axle having an electric motor associated therewith. The output of drive torque by the electric motor of the electric axle therefore first takes place in the power flow behind the hybrid transmission device. Preferably, the electric axle is an assembly unit. The assembly unit also includes a separate transmission for multiplying the drive torque of the electric motor of the electric axle. This is preferably a gear change transmission.

When an electric axle is utilized, this supports the drive torque.

An example aspect of the invention also relates to a motor vehicle with an internal combustion engine and a hybrid transmission device. The motor vehicle is distinguished by the hybrid transmission device described.

Advantageously, the hybrid transmission device is arranged in the motor vehicle as a front-mounted transverse transmission device.

Preferably, the motor vehicle includes a control device for the open-loop control of the hybrid transmission device. The control device is therefore part of the hybrid transmission device, although it does not need to be.

Preferably, a battery is arranged in the motor vehicle, which allows for an electric operation of the motor vehicle for at least 15 minutes. Alternatively, for a purely electric operation, the internal combustion engine, with one of the electric motors as a generator, generates current, which goes directly to the other electric motor.

In addition, the motor vehicle includes a pressure reservoir. This is utilized for operating a fluid power machine.

### BRIEF DESCRIPTION OF THE DRAWINGS

Further advantages, features, and details of the invention result from the following description of exemplary embodiments and figures, in which:

FIG. 1 shows a motor vehicle,

FIG. 2 shows a first example gear set scheme,

FIG. 3 shows a first example shift pattern,

FIG. 4 shows a second example shift pattern,

FIG. 5 shows a second example gear set scheme, and

FIG. 6 shows a third example gear set scheme.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

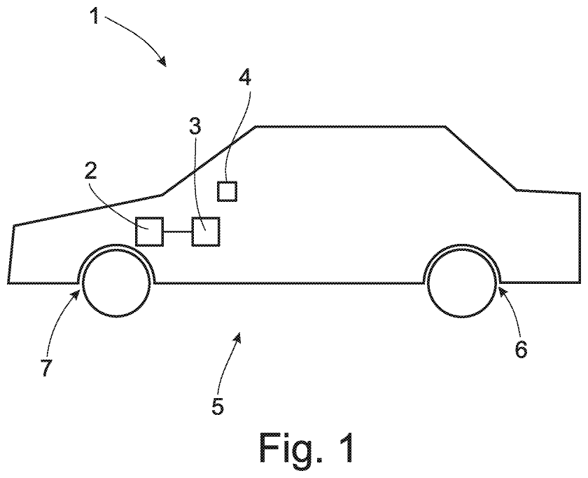

FIG. 1 shows a motor vehicle 1 with an internal combustion engine 2 and a hybrid transmission device 3. The hybrid transmission device 3 includes, as described in greater detail further below, one electric motor and shift elements, and so the transmission device 3 is installed as an assembly unit. This is not absolutely necessary, however. In principle, the gear set forms an assembly unit even without previously connected electric motors. A control device 4 is provided for the open-loop control of the hybrid transmission device 3. This is part of the hybrid transmission device 3 or of the motor vehicle 1.

The hybrid drive train 5 of the motor vehicle 1 also includes, in addition to the internal combustion engine 2 and the hybrid transmission device 3, at least one electric axle 6. The electric axle 6 is preferably the rear axle when the hybrid transmission device 3 is arranged as a front-mounted transverse transmission and drives the front axle 7, and vice versa.

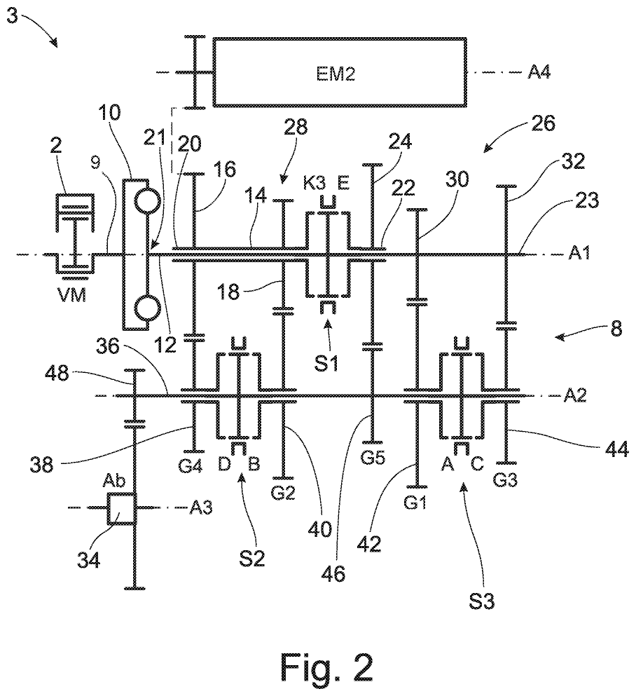

FIG. 2 shows the hybrid transmission device 3 and, in particular, a gear set scheme of its gear change transmission 8. In the following, the hybrid transmission device 3 will be described starting from the internal combustion engine 2. The crankshaft 9 is connected to the first transmission input shaft 12 via a damper unit 10. The damper unit 10 includes a torsion damper and/or a damper, in particular a rotational speed-adaptive damper, and/or a slipping clutch. A second transmission input shaft 14 is mounted on the first transmission input shaft 12.

A fixed gear 16 of the fourth gear step G4 and a fixed gear 18 of the second gear step G2 are arranged on the second transmission input shaft 14.

The first transmission input shaft 12 has an input end 21 facing the engine and an output end 23 facing away from the engine, wherein reference is made here to the position in comparison to the internal combustion engine 2. The second transmission input shaft 14 has two ends, namely one end 20 facing the outer side of the hybrid transmission device 3, closer to the internal combustion engine 2, and one end 22 facing the inner side of the hybrid transmission device 3, further from the internal combustion engine 2.

A connecting clutch K3 connects sub-transmissions 26, 28 of the transmission 3. As will be described below, the sub-transmissions 26, 28 together have five gear steps, including a first gear step G1, a second gear step G2, a third gear step G3, a fourth gear step G4, and a fifth gear step G5. The sub-transmission 26 has the odd gear steps G1, G3, G5. The sub-transmission 28 has the even gear steps G2, G4.

A gearshift clutch E, mounted on the first transmission input shaft 12, follows an engagement device S1 in the axial direction. Using the gearshift clutch E, an idler gear 24 of the fifth gear step G5 is rotationally fixable to the first transmission input shaft 12.

On the first transmission input shaft 12, a fixed gear 30 of the first gear step G1 and a fixed gear 32 of the third gear step G3 follow.

The second transmission input shaft 14 is therefore shift element-free and idler gear-free. The engagement device S1 is arranged on the first transmission input shaft 12. The engagement device S1 includes the connecting clutch K3 and the gearshift clutch E and, therefore, is two-sided.

The first transmission input shaft 12 and the second transmission input shaft 14 share an axis of rotation A1.

The hybrid transmission device 3 includes a single countershaft 36 for connection to a differential 34 and to form the gear stages or gear steps. Two engagement devices S2, S3 with the gearshift clutches A, B, C, D are arranged on the countershaft 36 for connecting the idler gears 38, 40, 42, 44 to the countershaft 36. As the only gear-implementing fixed gear, the fixed gear 46 of the fifth gear step G5 is located between the idler gears 38, 40, 42, 44 on the countershaft 36. The assignment to the gear steps results on the basis of the gear step numbers G1, G2, G3, G4, G5 below the gearwheels 38, 40, 42, 44, 46 arranged on the countershaft 36. The fixed gear 48 is not a gear-implementing fixed gear. Instead, the fixed gear 48 connects the countershaft 36 to the differential 34 as a so-called “drive output constant.” On the basis of this scheme, the following is determined with respect to the forward gear steps:

One fixed gear and one idler gear are associated with each gear step G1, G2, G3, G4, G5 and, in fact, a single fixed gear and a single idler gear in each case. Each pair of fixed gear and idler gear are always unambiguously associated with a single gear step, i.e., there are no winding-path gears by utilizing one gearwheel for multiple gear steps. Nevertheless, the second and fourth gear steps G2, G4 are considered to be coupling gears, since the first transmission input shaft 12 is interconnected during the formation of the second and fourth gear steps G2, G4.

The electric motor EM2 is connected at the axially external gearwheel 16. As a result, it is possible to connect the electric motor EM2 without an additional gearwheel on the transmission input shaft 14, as the result of which installation space is saved. In particular, due to the connection of the electric motor EM2 at the axially outermost gearwheel 16, an extremely axially short hybrid transmission device 3 is created.

The electric motor EM2, particularly its longitudinal axis A4, is arranged in parallel to the transmission input shaft 12.

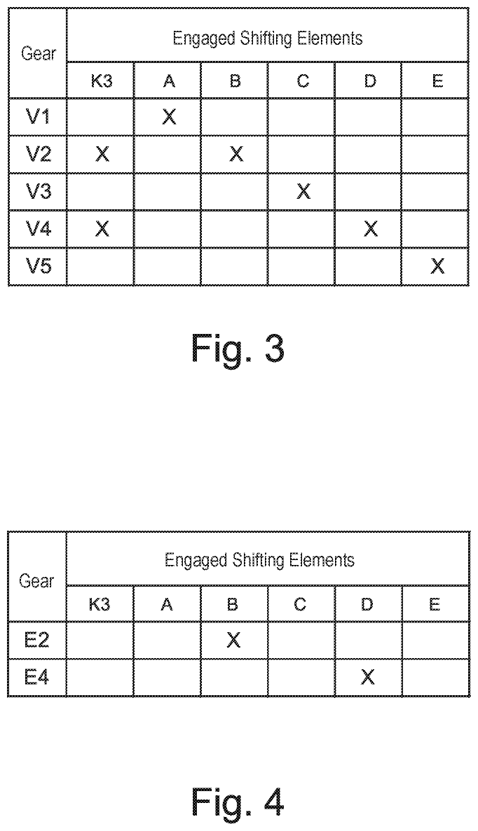

FIG. 3 shows a first example gear shift matrix for the hybrid transmission device 3 according to FIG. 2, in which it is apparent that five internal-combustion-engine gears are implemented, including a first internal-combustion-engine gear V1, a second internal-combustion-engine gear V2, a third internal-combustion-engine gear V3, a fourth internal-combustion-engine gear V4, and a fifth internal-combustion-engine gear V5. In contrast to a typical dual-clutch transmission, in which clutches are alternately disengaged and engaged during the shifting of the forward gears, the even internal-combustion-engine gears V2, V4 are implemented by the connecting clutch K3 being engaged while the odd internal-combustion-engine gears are implemented by disengaging the connecting clutch K3. A changeover between the sub-transmissions therefore preferably takes place via the disengagement and engagement of the connecting clutch K3. In contrast to typical dual clutch transmissions, the utilization of the clutch is therefore implemented in a deviating manner. As is already also apparent from FIG. 2, precisely one of the gearshift clutches A, B, C, D, E is engaged and in the power flow in each of the internal-combustion-engine forward gears.

FIG. 4 shows a second example gear shift matrix for the hybrid transmission device 3 according to FIG. 2, in which it is apparent that two electric-motor (forward) gears E2, E4 are implemented. For this purpose, only the second transmission input shaft 14 and the shift element S2, with one of the second and fourth clutches B, D in each case, are utilized.

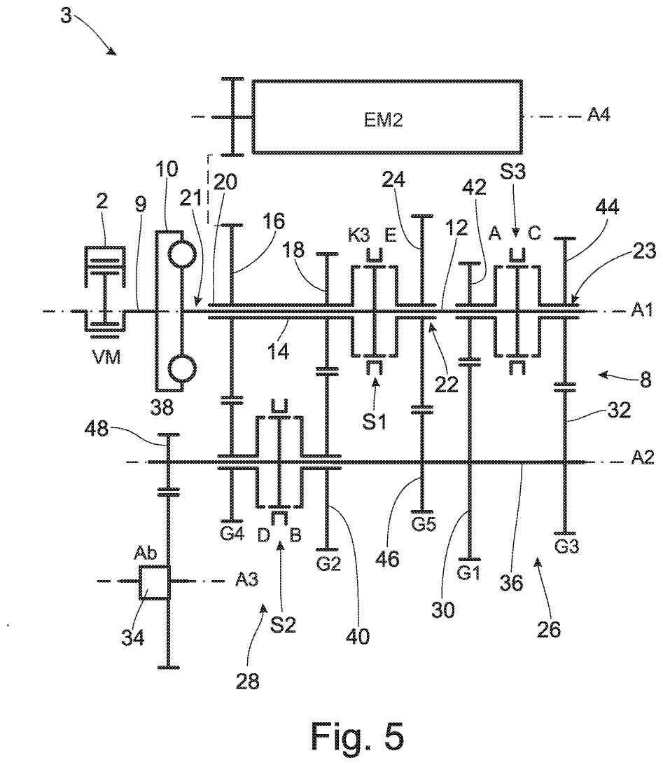

FIG. 5 shows a first alternative example arrangement of the gear change transmission 8 of the hybrid transmission device 3. Identical reference characters describe identical components. In comparison to FIG. 2, the arrangement of FIG. 5 is the same, except however, the idler gears 42, 44 and the engagement device S3 have been moved from the countershaft 36 onto the first transmission input shaft 12 and, accordingly, the fixed gears 30, 32 have been moved from the first transmission input shaft 12 onto the countershaft 36. Otherwise, FIGS. 3 and 4 are therefore also valid for FIG. 5.

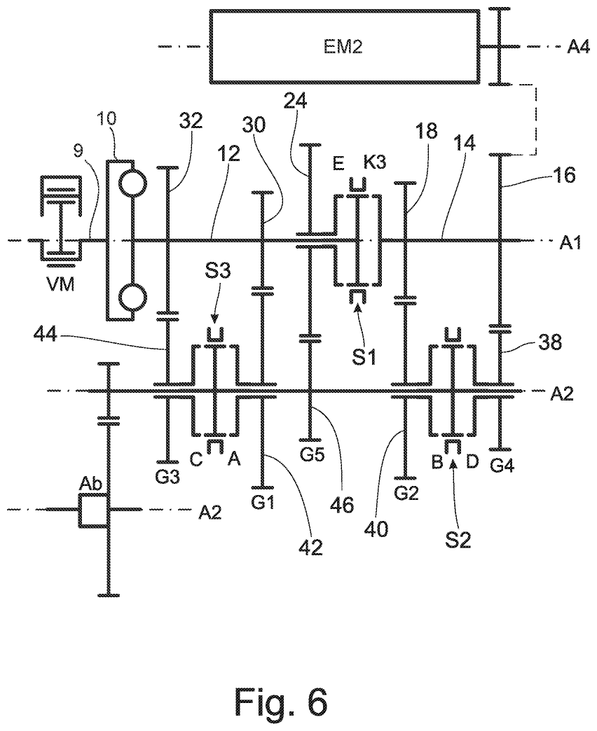

FIG. 6 shows a further alternative example arrangement of the gear change transmission 8 of the hybrid transmission device 3. In comparison to FIG. 2, the arrangement of the gear steps G1, G2, G3, G4, G5 is a mirror image with respect to the plane of the third gear step G3. Additionally, in FIG. 6, the second transmission input shaft 14 is instead arranged as an extension of the first transmission input shaft 12. Preferably, regardless of the further features of the hybrid transmission device 3, the second transmission input shaft 14 is therefore arranged on the same axis A1 with the first transmission input shaft 12, although axially offset. Otherwise, FIGS. 3 and 4 also remain valid in this case.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 motor vehicle
2 internal combustion engine
3 hybrid transmission device
4 control device
5 hybrid drive train
6 electric axle
7 front axle
8 gear change transmission
9 crankshaft
10 damper unit
12 first transmission input shaft
14 second transmission input shaft
16 fixed gear
18 fixed gear
20 end
21 end
22 end
23 end
24 idler gear
26 sub-transmission
28 sub-transmission
30 fixed gear
32 fixed gear
34 differential
36 countershaft
38 idler gear
40 idler gear
42 idler gear
44 idler gear
46 fixed gear
48 gearwheel
50 end facing the motor
K3 connecting clutch
S1 engagement device
S2 engagement device
S3 engagement device
A gearshift clutch
B gearshift clutch
C gearshift clutch
D gearshift clutch
E gearshift clutch
EM2 electric motor
A1 axis
A2 axis
A3 axis
A4 axis

1-15: (canceled)

16. A hybrid transmission device (3), comprising:
a first transmission input shaft (12);
a second transmission input shaft (14);
at least one drive device (EM2); and
a connecting clutch (K3) engageable to rotationally fix the first transmission input shaft (12) to the second transmission input shaft (14),
wherein the first transmission input shaft (12) extends between an input side (21) and an output side (23), the first transmission input shaft (12) being clutch-free on the input side (21).

17. The hybrid transmission device (3) of claim 16, wherein the connecting clutch (K3) is the only connecting clutch.

18. The hybrid transmission device (3) of claim 16, wherein the second transmission input shaft (14) extends between a first end (20) and a second end (22), the first end (20) of the second transmission input shaft (14) being closer than the second end (22) of the second transmission input shaft (14) to the input side (21) of the first transmission input shaft (12),
wherein the connecting clutch (K3) is at the second end (22) of the second transmission input shaft (14).

19. The hybrid transmission device (3) of claim 16, wherein the connecting clutch (K3) is part of a two-sided engagement device (S1).

20. The hybrid transmission device (3) of claim 16, further comprising gearshift clutches (A, B, C, D, E),
wherein each of one or more of the connecting clutch (K3) and the gearshift clutches (A, B, C, D, E) is a dog clutch.

21. The hybrid transmission device (3) of claim 16, wherein the at least one drive device comprises only one drive device (EM2), the one drive device (EM2) being coupled to only the second transmission input shaft (14).

22. The hybrid transmission device (3) of claim 16, further comprising precisely three, two-sided engagement devices (S1, S2, S3) for producing five internal-combustion-engine forward gears (V1, V2, V3, V4, V5).

23. The hybrid transmission device (3) of claim 16, wherein the connecting clutch (K3) is mounted on the first transmission input shaft (12).

24. The hybrid transmission device (3) of claim 16, further comprising precisely one engagement device (S1) on the first transmission input shaft (12).

25. The hybrid transmission device (3) of claim 16, further comprising precisely one countershaft (36).

26. The hybrid transmission device (3) of claim 25, further comprising precisely two engagement devices (S2, S3) on the countershaft (36).

27. The hybrid transmission device (3) of claim 25, further comprising precisely one fixed gear (46) on the countershaft (36) for forming a forward gear step (G3).

28. The hybrid transmission device (3) of claim 16, wherein the at least one drive device (EM2) is rotationally coupled to a fixed gear (16, 18).

29. A hybrid drive train (5) comprising the hybrid transmission device (3) of claim 16 and an electric axle (6).

30. A motor vehicle (1) comprising the hybrid drive train (5) of claim 29.
